(19) United States
(12) Patent Application Publication
(10) Pub. No.: US 2026/0296925 A1
(43) Pub. Date: Oct. 1, 2026

(54) THERMOCOMPRESSION MULTI-EFFECT WATER DISTILLER SYSTEM AND ITS CONTROL METHOD

(71) Applicant: SHANDONG MAIWO WATER PURIFICATION TECHNOLOGY CO., LTD., Weifang City (CN)

(72) Inventors: HAILUN ZHANG, Weifang City (CN); WENXU SUN, Weifang City (CN); CHANGCHAO LIU, Weifang City (CN); YUANMIN ZHANG, Weifang City (CN); AILING YAO, Weifang City (CN); LEI JIA, Weifang City (CN)

(73) Assignee: SHANDONG MAIWO WATER PURIFICATION TECHNOLOGY CO., LTD., Weifang City (CN)

(21) Appl. No.: 18/706,763

(22) PCT Filed: Mar. 8, 2024
(86) PCT No.: PCT/CN2024/080662

§ 371 Date: May 28, 2026

(30) Foreign Application Priority Data
Mar. 5, 2024 (CN) 202410248131.5

(51) Int. Cl. C02F 1/08

(52) U.S. Cl. CPC C02F 1/08

(57) ABSTRACT

The present invention discloses a thermocompression multi-effect water distiller system and its control method, within the technical field of water distillation. The system comprises a distillation unit and a control unit. The distillation unit features a multi-effect evaporator, specifically a horizontally arranged tube falling film evaporator placed side by side. The control unit oversees the operation of the distillation unit, employing a feedforward cascade fuzzy PID model predictive control system. This system comprises an inner loop control system utilizing fuzzy PID control, with additional control for industrial steam pressure fluctuation. An outer loop control system employs model predictive control. This innovation enhances heat exchange efficiency and introduces a novel control system capable of ensuring normal operation within a range of 40%-200% of the set working conditions.

### TECHNICAL FIELD

The present invention relates to the technical field of water distiller, in particular to a thermocompression multi-effect water distiller system and its control method.

### BACKGROUND ART

Distillation is the only method for preparing water for injection recognized by Chinese Pharmacopoeia, how to reduce the energy consumption in the production process and improve the automation level through technological innovation is a key problem to be solved urgently.

At present, there are two kinds of equipment for preparing water for injection by distillation in the industry: multi-effect water distiller and thermocompression water distiller.

The basic principle of the multi-effect water distiller is: that the feedstock water at room temperature reaches a higher temperature after passing through multi-stage heat exchangers such as condensers and preheaters, and then enters the tube side of the first-effect vertical tube evaporator, evenly distributed to the inner wall of the heat exchange tube to form a liquid film. Meanwhile, high-temperature steam enters the shell side of the heat exchanger, and the steam temperature is higher than the feedstock water temperature, the two media exchange heat through the heat exchange tube wall, and the steam outside the tube is exothermic and condensed into product water, the steam generated by the evaporation of feedstock water in the tube enters the shell side of the next-effect, and the unevaporated feedstock water enters the tube side of the next-effect, repeat the above process until the last-effect, and all the steam generated by the last-effect enters the condenser and condenses into product water. However, the inventor found that the device has the following disadvantages: the evaporator uses vertical tube falling film technology to produce water, and the heat exchange efficiency is low; the pressure difference between the inlet and outlet steam of the system is large, which makes it difficult to recycle the outlet steam, resulting in a huge waste of energy; the system control method is old, the control effect is not good, and it is difficult to be in the optimal operation state.

The thermocompression water distiller has begun to be promoted in the industry in recent years, and the system steam internal circulation is realized through the steam compressor, and the water production cost can be reduced by half. The basic principle is that the industrial steam is used as a heat source of a steam regenerator, purified water absorbs heat and evaporates to generate pure steam, then the pure steam enters an evaporator heat exchange tube, and exchanges heat with the feedstock pure water which is sprayed outside the heat exchange tube after preheating, the generated steam enters the evaporator heat exchange tube again after being boosted by the steam thermal compressor to realize the system steam internal circulation. However, the inventor found that the device has the following disadvantages: the steam compressor impeller has high speed, high work intensity, and is not only costly but also easy to damage, so the equipment maintenance cost is high.

### SUMMARY

The objective of the present invention is to provide a thermocompression multi-effect water distiller system and its control method, and the heat exchange efficiency is greatly improved, and a new control system is proposed, which can realize the normal operation in the range of 40%-200% of the set working condition, and ensure that the equipment can be in a stable and efficient operation state.

In order to achieve the above objective, the present invention provides a thermocompression multi-effect water distiller system, comprising a distillation unit and a control unit;
the distillation unit comprises a multi-effect evaporator;
the multi-effect evaporator is a horizontal tube falling film evaporator and is arranged side by side, a shell side of the former-effect evaporator is connected with a tube side of the latter-effect evaporator;
the control unit controls the distillation unit during the working process, the control unit is a feedforward cascade fuzzy PID model predictive control system, which comprises an inner loop control system and an outer loop control system;
the inner loop control system is fuzzy PID control, and a control system for industrial steam pressure Pₛₜₑₐₘ fluctuation is arranged on the inner loop control system;
the outer loop control system is model predictive control.

Preferably, the distillation unit also comprises a pure steam generator, a steam ejector, a feedstock pure water buffer tank, a condensate water buffer tank, and a waste heat recovery system;
the waste heat recovery system is used to preheat the feedstock pure water, and a feedstock pure water pump, a concentrated drainage preheater, an industrial condensate water secondary preheater, a condenser, a product water preheater and an industrial condensate water primary preheater are arranged successively from the feedstock pure water end;
a water inlet end of the pure steam generator tube side is connected with the feedstock pure water buffer tank via a steam generator pump, and a steam inlet end of the shell side is connected with an industrial steam pipeline; an industrial condensate water discharge end is connected with the industrial condensate water primary preheater, and a concentrated drainage discharge end is connected with the concentrated drainage preheater.

Preferably, in the multi-effect evaporator, a steam inlet end of a first-effect evaporator is connected with an outlet end of the steam ejector, and a secondary inlet end of the steam ejector is connected with a steam outlet end of a last-effect evaporator;
the last-effect evaporator is also connected with the condenser, the feedstock pure water buffer tank and the condensate water buffer tank respectively, wherein, a steam outlet of a condensation side head of the last-effect evaporator is connected with an inlet of the shell side of the condenser, an evaporation residual water outlet of an intermediate cylinder of the last-effect evaporator is connected with the feedstock pure water buffer tank, and the condensate water outlet of the condensation side head of the last-effect evaporator is connected with the condensate water buffer tank;
the feedstock pure water buffer tank is connected with the industrial condensate water primary preheater via a circulating water pump, and the industrial condensate water primary preheater is connected with a spray liquid distribution system of the multi-effect evaporator; a liquid distributor is arranged on the spray liquid distribution system;
the number of liquid distributors is the same as the number of effects of multi-effect evaporators, and each liquid distributor is located directly above each effect evaporator.

Preferably, a pure steam outlet end of the pure steam generator is connected to a primary inlet of the steam ejector.

Preferably, the last-effect evaporator is also connected with the condensate water buffer tank, the condensate water buffer tank outputs product water through a product water row pipe, the product water row pipe comprises a first-row pipe, an end of the first-row pipe is connected with a second-row pipe of qualified product water and a third-row pipe of unqualified product water respectively, the water quality is detected by an online conductivity detector, and then the switches of the second-row pipe valve and the third-row pipe valve are controlled;
a product water pump is arranged on the first-row pipe.

The present invention also provides a control method for a thermocompression multi-effect water distiller system, the inner loop control system is a single-input and single-output control, for controlling the flow rate via the pump and controlling the steam pressure via a valve opening, according to a deviation and a deviation change rate of a current controlled quantity, a fuzzy control method is used to form a fuzzy control rule;
the outer loop control system is model predictive control, and a system performance, a reference trajectory tracking performance and a change degree of the inner loop setting value are taken as an optimization objective, based on the inner loop setting value and the state constraint conditions of the thermocompression multi-effect water distiller system, a rolling optimization model is established:

$$min J ( k ) = {\sum }_{i = 1}^{P} {q}_{i} \cdot {[ w ( k + i ) - {y}_{p} ( k + i \vert k ) ]}^{2} + {\sum }_{j = 1}^{M} [ {p}_{i} \cdot Δ {r}_{sp}^{2} ( k + j - 1 ) + {λ}_{i} \cdot {EX}^{2} ( {r}_{s p} ( k + j ) ) ]$$

$$s . t . {x}_{min} \leq x ( k + i \vert k ) \leq {x}_{max} , i = 1 , 2 , … , P$$

$${r}_{sp , min} \leq {r}_{s p} ( k + j ) \leq {r}_{sp , max} , j = 1 , 2 , … , M$$

$$Δ {r}_{sp , min} \leq Δ {r}_{s p} ( k + j - 1 ) \leq Δ {r}_{sp , max} , j = 1 , 2 , … , M$$

where J(k) is a set optimization objective function; EX(rₛₚ) is a system performance evaluation function; w(k+i) and yₚ(k+i|k) are a reference trajectory for the moment of k+i moment and a predicted output for k+i moment at k moment, respectively; xₘᵢₙ and xₘₐₓ are minimum and maximum values of key state parameters of the system; x(k+i|k) is a predicted value of the system state parameters at k moment for k+i moment; r_{sp,min} and r_{sp,max} are minimum and maximum values of the output value of the model predictive controller to the inner loop controller; rₛₚ(k+j) is an output value of model predictive controller to the inner loop controller at k+j moment; Δr_{sp,min} and Δr_{sp,max} are minimum and maximum change rates of the output values of the model predictive controller to the inner loop controller; Δrₛₚ(k+j−1) is a change rate of the output value of the model predictive controller to the inner loop controller at k+j−1 moment; P is a prediction time domain; i is a i^{th} moment of the prediction time domain; M is a control time domain; j is a j^{th} moment of the control time domain; pᵢ, λᵢ and qᵢ are weight coefficients at the i^{th} moment.

Preferably, the control system for industrial steam pressure Pₛₜₑₐₘ fluctuation comprises an ejector working condition control system and an evaporator liquid level control system;
the ejector working condition control system ensures that a water production ratio of the system is not less than 8;
the evaporator liquid level control system controls the opening of the inter-effect control valve to keep the liquid level of the inter-effect between 5-35 cm during the industrial steam pressure Pₛₜₑₐₘ fluctuation.

Preferably, for the steam ejector working condition control, by modeling the steam ejector, an outlet pressure P_{c} and a secondary flow pressure Pₛ of the steam ejector that meet the ejection performance of the steam ejector under different primary inlet pressures Pₘ are obtained, by controlling the outlet pressure P_{c} and the secondary flow pressure Pₛ of the steam ejector, controlling the ejection performance of the steam ejector is realized, the purpose of the system's water production ratio not less than 8 is achieved;
for the steam ejector modeling method, because the ejector is a nonlinear link, the modeling method is based on a data-driven modeling method; data of the fluctuation range of industrial steam pressure satisfies the secondary flow pressure Pₛ and outlet pressure P_{c} of the ejection performance of the steam ejector is obtained, in the actual control, control targets of the secondary flow pressure Pₛ and the outlet pressure P_{c} of the steam ejector are obtained via the look-up table method, so as to achieve the purpose of linearizing the steam ejector;
the outlet pressure P_{c} control mode of the steam ejector is to control the outlet pressure P_{c} of the steam ejector via controlling the outlet steam flow of the steam ejector and controlling the temperature of the first-effect evaporator;
the outlet pressure P_{c} control mode of the steam ejector adopts a cascade control system, the inner loop of the system controls the steam flow by PID controlling the regulating valve opening, and the outer loop controls the outlet pressure of the steam ejector by adjusting the set value of steam flow via model predictive control, and a set value of an outlet pressure P_{c_s} of steam ejector is obtained via looking up the table;
the secondary flow pressure Pₛ control method of steam ejector controls the steam pressure of the condenser by controlling the feed rate of feedstock water, and further controls the secondary flow pressure Pₛ of the steam ejector;
the secondary flow pressure Pₛ control method of steam ejector adopts a cascade control system, the inner loop of the system controls the inlet feedstock water flow by PID controlling the feed pump frequency, the outer loop controls the secondary flow pressure of the steam ejector by model predictive control controlling the set value of the inlet feedstock water flow, and the set value of a secondary flow pressure P_{s_s} of the steam ejector is obtained via looking up the table.

Preferably, a liquid level control method of the evaporator is based on the model predictive control method, wherein the liquid level control system of each effect is taken as a subsystem, and a main system is a combination with the liquid level data of each effect, issues control requirements to each subsystem to realize a distributed model predictive control structure;
the control requirement issued by the main system is the Nash optimal solution obtained according to the Nash optimization;
the subsystem control method establishes the relationship equation of evaporator pressure, liquid level and inter-effect flow by means of mechanism modeling, so as to achieve the purpose of accurately controlling the liquid level by controlling the inter-effect flow;
the subsystem control method adopts feedforward plus cascade model predictive control, the inner loop adopts PID control, the inter-effect flow is controlled by controlling the inter-effect valve opening, and the outer loop adopts model predictive control to modify the PID set value of the inter-effect flow according to the evaporator liquid level, and the evaporator pressure further modifies the PID set value of the inter-effect flow through feedforward control.

Therefore, the present invention adopts the above-mentioned thermocompression multi-effect water distiller system and its control method, and the technical effects thereof are as follows:
(1) using horizontal tube falling film evaporation technology, pure steam enters the evaporator heat exchange tube, feedstock pure water is sprayed uniformly on the outer wall of the heat exchange tube through the spraying liquid distribution system to form a uniform liquid film, and the heat exchange efficiency is greatly improved;
(2) the technology of recovering low-grade steam by steam ejector was introduced, and the low-grade steam of the last-effect evaporator was recovered to realize the internal circulation of steam, the thermocompression multi-effect water distiller system uses a steam ejector to replace the compressor of thermocompression water distiller system, the steam ejector is a purely mechanical structure with no moving parts, and has low processing cost and long service life;
(3) a new control system is proposed, which can realize the normal operation in the range of 40%-200% of the set working conditions, and ensure the stable and efficient operation of the equipment;
(4) the thermocompression multi-effect water distiller can not only achieve the energy consumption level and water production cost of a thermocompression water distiller, but also have a simple mechanical structure.

Further detailed descriptions of the technical scheme of the present invention can be found in the accompanying drawings and examples.

### BRIEF DESCRIPTION OF THE DRAWINGS

FIG. 1 is an overall schematic view of a thermocompression multi-effect water distiller system according to the present invention;

FIG. 2 is an enlarged view of a portion of a steam ejector;

FIG. 3 is an enlarged view of a portion A of FIG. 1;

FIG. 4 is a schematic diagram of a horizontal tube falling film evaporator;

FIG. 5 is a diagram of a feedforward cascade fuzzy PID model predictive control system;

FIG. 6 is a diagram of a steam ejector working condition control system;

FIG. 7 is a diagram of a single-effect liquid level control system.

### DRAWING MARKS

1. a multi-effect evaporator; 101. an inlet steam side head; 102. a steam baffle plate; 103. an intermediate cylinder; 104. a scum skimmer; 105. a condensation side head; 2. a pure steam generator; 3. a steam ejector; 301. an outlet end; 302. a primary inlet; 303. a secondary inlet; 4. a feedstock pure water buffer tank; 5. a condensate water buffer tank; 6. a waste heat recovery system; 601. a concentrated drainage preheater; 602. an industrial condensate water secondary preheater; 603. a condenser; 604. a product water preheater; 605. an industrial condensate water primary preheater; 7. a circulating water pump; 8. a spray liquid distribution system; 801. a liquid distributor; 9. a feedstock pure water pump; 10. a product water row pipe; 11. a first-row pipe; 12. a second-row pipe; 13. a third-row pipe; 14. a product water pump; 15. a steam generator pump.

### DETAILED DESCRIPTION OF THE EMBODIMENTS

The technical solution of the present invention will be further elaborated hereafter in conjunction with accompanying drawings and examples.

Unless otherwise defined, technical or scientific terms used in the present invention are to be given their ordinary meaning as understood by those of ordinary skill in the art to which the present invention belongs.

### Example 1

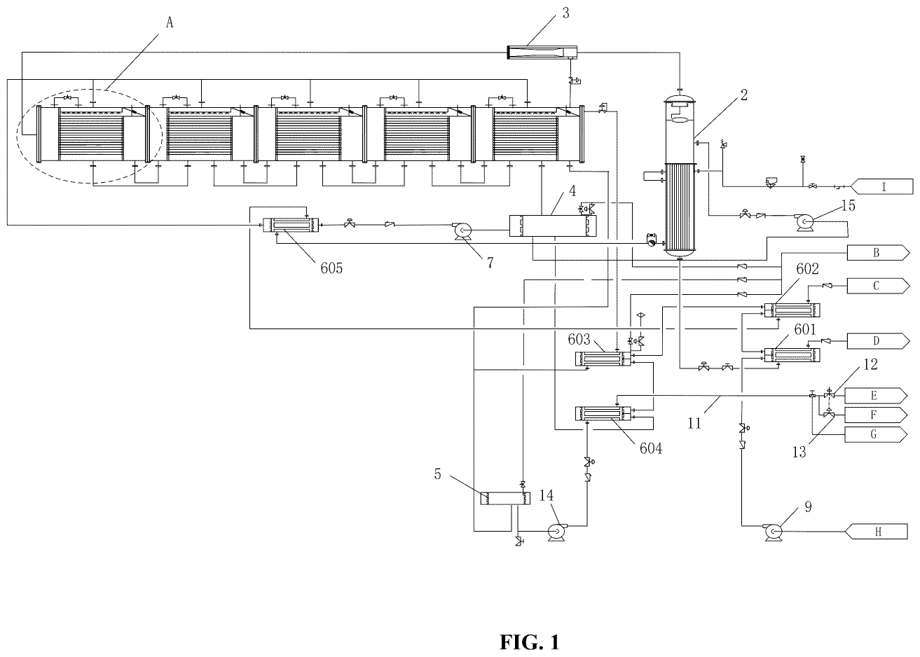

as shown in FIG. 1 is an overall schematic view of a thermocompression multi-effect water distiller system in the present invention, which comprises a distillation unit and a control unit;
the distillation unit comprises a multi-effect evaporator 1; this example is a quintuple-effect evaporator; in FIG. 1, I is industrial steam, B is non-condensable gas, C is industrial condensed water, D is concentrated drainage, E is qualified injection water, F is unqualified injection water, G is sampling port, and H is feedstock pure water.

Non-condensable gas is a gas that cannot be condensed into liquid water in the system, it mainly refers to the residual air in the system before the operation of the system and the air mixed with steam and feedstock water.

The multi-effect evaporator 1 is a horizontal tube falling film evaporator and is arranged side by side, the shell side of the former-effect evaporator is connected with the tube side of the latter-effect evaporator; compared with the vertical tube falling film evaporation technology, the pure steam enters the evaporator heat exchange tube, and the feedstock pure water is sprayed uniformly on the outer wall of the heat exchange tube through the spraying liquid distribution system to form a uniform liquid film, and the heat exchange efficiency is greatly improved.

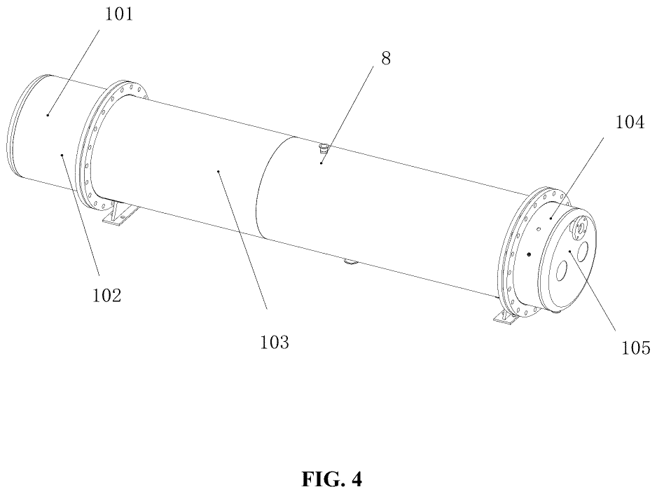

As shown in FIG. 4, the horizontal tube falling film evaporator is the core component of the thermocompression multi-effect water distiller, which is mainly composed of an inlet steam side head 101, a condensation side head 105 and an intermediate cylinder 103. A steam baffle plate 102 is arranged in the inlet steam side head 101 to make the steam enter the heat exchange tube bundle evenly; a scum skimmer 104 is arranged in the condensation side head 105, which is used to remove the feedstock water droplets in the steam; the intermediate cylinder 103 welded heat exchange tube is used for heat exchange between feedstock pure water and pure steam, the spray liquid distribution system 8 is welded above the intermediate cylinder 103 for uniform liquid distribution of feedstock pure water.

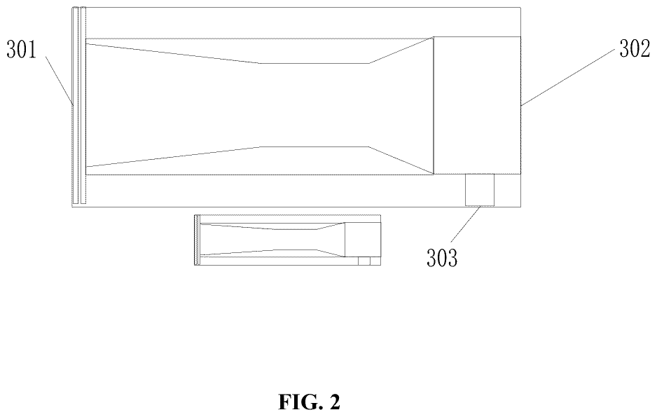

The distillation unit also comprises a pure steam generator 2, a steam ejector 3, a feedstock pure water buffer tank 4, a condensate water buffer tank 5 and a waste heat recovery system 6; FIG. 2 is an enlarged view of the steam ejector 3.

The waste heat recovery system 6 is successively provided with a feedstock pure water pump 9, a concentrated drainage preheater 601, an industrial condensate water secondary preheater 602, a condenser 603, a product water preheater 604 and an industrial condensate water primary preheater 605 from the feedstock pure water end, and the waste heat recovery system 6 is used to preheat the feedstock pure water. The water inlet temperature of the feedstock pure water is 20° C., firstly, passes through the concentrated drainage preheater 601 and to exchange heat with the concentrated drainage of 160° C. discharged from the pure steam generator 2, the feedstock pure water is preheated to about 22° C., and the concentrated drainage temperature is reduced to about 40° C. to achieve low temperature discharge; then the feedstock pure water passes through the industrial condensate water secondary preheater 602 and to exchange heat with the 110° C. industrial condensation water discharged from the industrial condensate water primary preheater 605, the feedstock pure water is preheated to about 27° C., and the temperature of the industrial condensation water falls below 50° C. and is discharged at a low temperature; then the feedstock pure water passes through the condenser 603 and to exchange heat with the 102° C. saturated steam discharged from the last-effect evaporator, the pure water of the feedstock is preheated to about 85° C., and the steam is condensed into 102° C. condensed water and then enters the condensate water buffer tank 5; then the feedstock pure water passes through the product water preheater 604 to exchange heat with the product water about 102° C. discharged from the condensate water buffer tank 5, the feedstock pure water is preheated to 93° C. and then enters the feedstock pure water buffer tank 4 to be mixed with the residual water after the last-effect is collected into the buffer tank, and the temperature of the product water is reduced to 80-95° C. according to actual requirements and then is discharged from the system; the temperature of the feedstock pure water after mixed in the feedstock pure water buffer tank 4 is about 97° C., and then passes through the industrial condensation water primary preheater 605 and to exchange heat with the 160° C. industrial condensation water discharged from the pure steam generator 2, the feedstock pure water is preheated to about 101° C. and enters the spray liquid distribution system 8 of the first-effect evaporator, and the industrial condensate water enters the industrial condensate water secondary preheater 602 after the temperature it drops to 110° C.

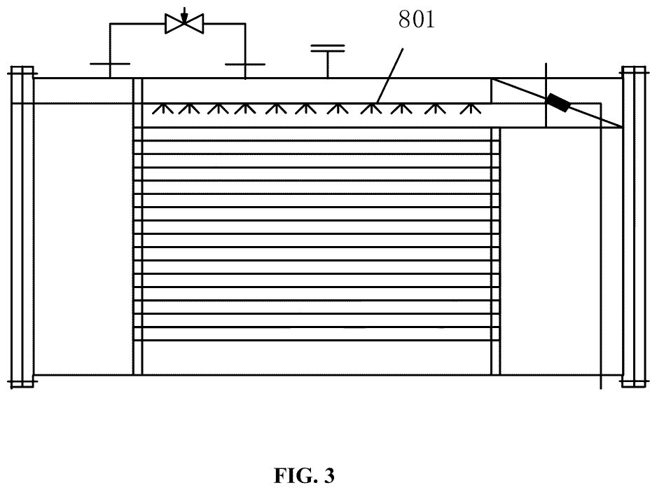

In the multi-effect evaporator 1, a steam inlet end of the first-effect evaporator is connected with an outlet end 301 of the steam ejector 3, and a secondary inlet end 303 of the steam ejector 3 is connected with a steam outlet end of a last-effect evaporator;
the last-effect evaporator is also connected with the condenser 603, and the feedstock pure water buffer tank 4, respectively;
one side of the feedstock pure water buffer tank 4 is provided with a circulating water pump 7, the other end of the circulating water pump 7 is connected to an industrial condensate water primary preheater 605, and the industrial condensate water primary preheater 605 is connected to a spray liquid distribution system 8 of the multi-effect evaporator 1;
as shown in FIG. 3, a liquid distributor 801 is arranged on the spray liquid distribution system 8; the number of liquid distributors 801 is the same as the number of effects of multi-effect evaporators 1, and each liquid distributor 801 is located directly above each effect evaporator.

One end of the pure steam generator 2 is connected to the industrial steam and the buffer water tank, a pure steam outlet end of the pure steam generator 2 is connected to the primary inlet 302 of the steam ejector 3, and a steam generator pump 15 is provided between the pure steam generator 2 and the buffer water tank for generating steam.

The last-effect evaporator is also connected with the condensate water buffer tank 5, the condensate water buffer tank 5 outputs product water through a product water row pipe 10, the product water row pipe 10 comprises a first-row pipe 11, an end of the first-row pipe 11 is connected with a second-row pipe 12 of qualified product water and a third-row pipe 13 of unqualified product water, the water quality is detected by an online conductivity detector, and then the switches of the second-row pipe valve and the third-row pipe valve are controlled; a product water pump 14 is arranged on the first-row pipe 11 for pumping out product water.

In operation, raw pure water is preheated by a waste heat recovery system 6 (a concentrated drainage preheater 601, an industrial condensate water secondary preheater 602, a condenser 603, a product water preheater 604 and an industrial condensate water primary preheater 605), and then uniformly sprayed onto the outer wall of the heat exchange tube via a liquid distributor to form a uniform liquid film. The industrial steam and the water in the buffer water tank are converted into pure steam through the pure steam generator 2, and are used as a power source of a steam ejector to eject steam generated by a last-effect evaporator; after two streams of steam are mixed, the steam enters the heat exchange tube of the horizontal tube falling film evaporator from the outlet of the steam ejector, and there is a temperature difference between the inside and the outside of the heat exchange tube; the steam in the tube is condensed into water for injection and collected for discharge; pure steam generated by pure water evaporation from the outside of the tube enters the heat exchange tube of the next-effect evaporator; the excess un-evaporated feedstock pure water enters the outside of the heat exchange tube of the next-effect evaporator to form a uniform liquid film, and circulates successively until to the last-effect evaporator.

The pipeline connection and various valves arranged on the pipeline in the present invention are conventional arrangements and are well-known to a person skilled in the art.

The control unit controls the distillation unit during the working process, the control unit is a feedforward cascade fuzzy PID model predictive control system, which comprises an inner loop control system and an outer loop control system;
the inner loop control system is fuzzy PID control, and a control system for industrial steam pressure Pₛₜₑₐₘ fluctuation is arranged on the inner loop control system;
the outer loop control system is model predictive control.

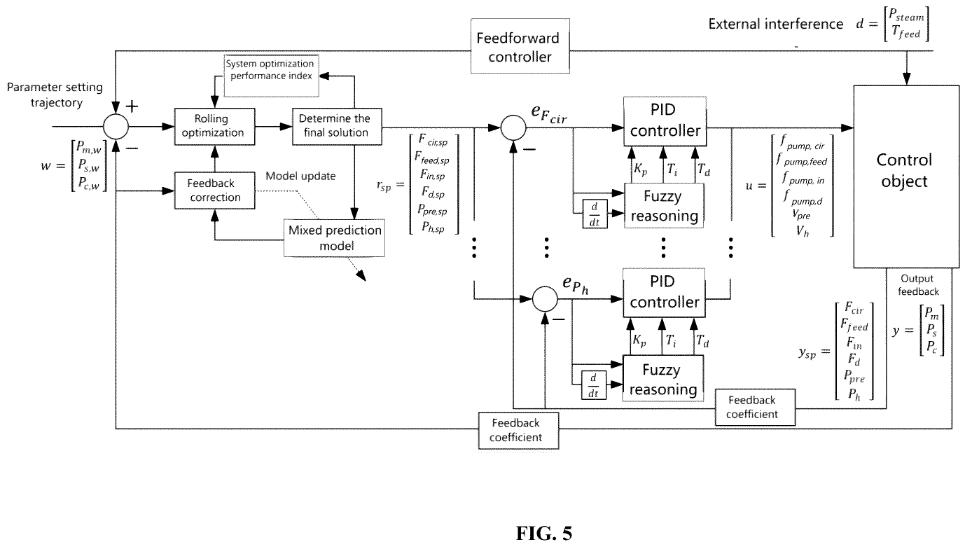

As shown in FIG. 5, is a diagram of a feedforward cascade fuzzy PID model predictive control system.

(1) According to the process flow of the equipment, the intermediate controlled variables of the control system are mainly circulating water flow F_{cir}, feedstock water flow F_{feed}, inlet feedstock water flow Fᵢₙ, product water flow F_{d}, preheating steam pressure Pₚᵣₑ and heating steam pressure Pₕ. Since the flow control is realized by the water pump, and the pressure control is realized by the steam pressure regulating valve, the control amount u is the frequency of each pump and the opening of the pressure regulating valve:

$$u = {[ {f}_{pump , cir} , {f}_{pump , feed} , {f}_{pump , in} , {f}_{pump , d} , {V}_{pre} , {V}_{h} ]}^{T} \qquad ( 1 )$$

where f_{pump,cir} is the frequency of the circulating pump; f_{pump,feed} is the feed pump frequency; f_{pump,in} is the feed pump frequency of the steam generator; f_{pump,d} is the product water pump frequency; Vₚᵣₑ is the valve opening of the steam preheating pipeline; Vₕ is the opening of the industrial steam valve;
for this equipment, the performance of the steam ejector determines the recovery and utilization rate of the steam; for the consideration of energy-saving optimization control, the control system needs to regulate and control the three-port pressure to ensure that the steam ejector operates in an optimal state, and then the final output y of the system is the primary flow pressure Pₘ, the secondary flow pressure Pₛ and the outlet pressure P_{c} of the steam ejector;

$$y = {[ {P}_{m} , {P}_{s} , {P}_{c} ]}^{T} \qquad ( 2 )$$

In industrial applications, industrial steam and inlet feedstock water are provided by the factory, affected by the peak period of steam use, industrial steam pressure will fluctuate, similarly, different sources of inlet feedstock water will also change the temperature of inlet feedstock water, therefore, the main disturbance variables d of the system are industrial steam pressure Pₛₜₑₐₘ and inlet feedstock water temperature T_{feed}:

$$d = {[ {P}_{steam} , {T}_{feed} ]}^{T} \qquad ( 3 )$$

Based on the analysis of the process flow of the system, there is a strong coupling relationship between the input and output of the system, in which the primary flow pressure Pₘ of the steam ejector has a strong coupling relationship with the heating steam pressure Pₕ and the inlet feedstock water flow Fᵢₙ, and it is also influenced by the disturbance variable industrial steam pressure Pₛₜₑₐₘ; the secondary flow pressure Pₛ has a strong coupling relationship with the preheating steam pressure Pₚᵣₑ and the feedstock water flow F_{feed}, and is influenced by the disturbance variable inlet feedstock water temperature Treed as well; there is a strong coupling relationship between the outlet pressure P_{c} and the circulating water flow F_{cir} and the preheating steam pressure Pₚᵣₑ, and as also influenced by the disturbance variable industrial steam pressure Pₛₜₑₐₘ and the inlet feedstock water temperature T_{feed}.

In summary, the structure of the system is complex and has obvious time delay units, which belong to a large time delay, strong coupling, and nonlinear multi-input multi-output system.

(2) For the large time delay, strong coupling and nonlinear systems with multi-input and multi-output, it is difficult to precisely control the system output by controlling only one input, therefore, it is necessary to adopt the idea of global overall control to select the global control method which can effectively eliminate the influence of time delay. Under these conditions, the use of model predictive control is more appropriate, compared with other control methods, model predictive control does not need too accurate model, and in practical applications, the system model will not be static, the feedback correction link in the model prediction can effectively reduce the impact of external interference and model mismatch, and improve the robustness of the control system.

In order to design a specific control system, it is necessary to design a feedforward control loop to eliminate the interference effect, considering that the measurable external interference exists in the control object. In addition, for the control of large industrial systems, due to the large amount of calculation of model predictive control, it is difficult to meet the requirements of the underlying control speed, so the cascade model predictive control is often used. Wherein PID control is used as the inner loop of cascade control to meet the speed requirements of the underlying control, and model predictive control is used as the outer loop to modify the set value of the inner loop controller at a certain speed. Under this condition, the inner loop control becomes a simple single-input and single-output control, for controlling the flow through the pump and controlling the steam pressure through the valve opening, with the knowledge of relevant experts, the fuzzy control method can be used to form fuzzy control rules and improve the inner loop control effect according to the deviation and deviation change rate of the current controlled variables.

In FIG. 5, w denotes the desired output of the system, and P_{m,w}, P_{s,w}, and P_{c,w} denote the desired outputs of the steam ejector primary flow pressure Pₘ, secondary flow pressure Pₛ, and outlet pressure P_{c}, respectively; rₛₚ denotes an inner loop controller set point, and F_{cir,sp}, F_{feed,sp}, F_{in,sp}, F_{d,sp}, P_{pre,sp} and P_{h,sp} denote an inner loop controller set point of the circulating water flow F_{cir}, the feedstock water flow F_{feed}, the inlet feedstock water flow Fᵢₙ, the product water flow F_{d}, the preheating steam pressure Pₚᵣₑ and the heating steam pressure Pₕ, respectively; u denotes a control amount output of the inner loop controller; yₛₚ is an inner loop output feedback; e_{F}_{_{cir}} and e_{P}_{ₕ} are the control errors of the inner loop circulating water flow F_{cir} and the heating steam pressure Pₕ, respectively; Kₚ, Tᵢ, and T_{d} denote the proportionality coefficient, integration time, and differentiation time of the fuzzy inference inner loop PID controller, respectively.

The selection of the optimal performance index of model predictive control will take a system performance, a reference trajectory tracking performance and a change degree of the inner loop setting value as an optimization objective, based on the inner loop setting value and the state constraint conditions of the system, a rolling optimization model is established:

$$min J ( k ) = {\sum }_{i = 1}^{P} {q}_{i} \cdot {[ w ( k + i ) - {y}_{p} ( k + i \vert k ) ]}^{2} + {\sum }_{j = 1}^{M} [ {p}_{i} \cdot Δ {r}_{sp}^{2} ( k + j - 1 ) + {λ}_{i} \cdot {EX}^{2} ( {r}_{s p} ( k + j ) ) ]$$

$$s . t . {x}_{min} \leq x ( k + i \vert k ) \leq {x}_{max} , i = 1 , 2 , … , P$$

$${r}_{sp , min} \leq {r}_{s p} ( k + j ) \leq {r}_{sp , max} , j = 1 , 2 , … , M$$

$$Δ {r}_{sp , min} \leq Δ {r}_{s p} ( k + j - 1 ) \leq Δ {r}_{sp , max} , j = 1 , 2 , … , M$$

where J(k) is a set optimization objective function; EX(rₛₚ) is a system performance evaluation function; w(k+i) and yₚ(k+i|k) are a reference trajectory for the moment of k+i moment and a predicted output for k+i moment at k moment, respectively; xₘᵢₙ and xₘₐₓ are minimum and maximum values of key state parameters of the system; x(k+i|k) is a predicted value of the system state parameters at k moment for k+i moment; r_{sp,min} and r_{sp,max} are minimum and maximum values of the output value of the model predictive controller to the inner loop controller; rₛₚ(k+j) is an output value of model predictive controller to the inner loop controller at k+j moment; Δr_{sp,min} and Δr_{sp,max} are minimum and maximum change rates of the output values of the model predictive controller to the inner loop controller; Δrₛₚ(k+j−1) is a change rate of the output value of the model predictive controller to the inner loop controller at k+j−1 moment; P is a prediction time domain; i is a i^{th} moment of the prediction time domain; M is a control time domain; j is a j^{th} moment of the control time domain; pᵢ, λᵢ and qᵢ are weight coefficients at a i^{th} moment.

The intelligent optimization algorithm is used to solve the constrained quadratic optimization problem, and M inner loop setting value increments are obtained.

(3) Because the fluctuation of industrial steam pressure Pₛₜₑₐₘ will have a negative impact on the operation of medical injection water preparation equipment, an additional control system is designed for the fluctuation of industrial steam pressure Pₛₜₑₐₘ on the basis of the above functions. For conventional medical water preparation equipment, its control system is mainly based on simple PID control, if rapid steam pressure fluctuation is encountered, it will not only seriously affect the system water production ratio and system heat exchange efficiency, but also cause production accidents.

The equipment is characterized by the design of large-scale variable working conditions, for the case where the steam generator pressure fluctuates between 0.4-0.8 Mpa, the equipment does not need to be manually regulated, and the equipment control system can automatically complete the equipment control work to ensure the efficient and safe operation of the equipment. In practical applications, it can not only effectively reduce the impact of sudden pressure fluctuations on production, but also reduce the requirements of equipment for steam pressure and expand the application field of equipment.

The equipment control system is characterized by being able to adapt to the pressure fluctuation of 0.4-0.8 Mpa steam generator and keep the system water ratio not less than 8.

For the current process flow of the equipment, the control system for industrial steam pressure Pₛₜₑₐₘ fluctuation comprises an ejector working condition control system and an evaporator liquid level control system. The realization of the control effect of the ejector working condition is characterized by controlling the working condition of the ejector to ensure that the ejection coefficient of the ejector is not greatly changed due to the industrial steam pressure Pₛₜₑₐₘ, so as to achieve the purpose of ensuring that the water production ratio of the system is not less than 8. The realization of the evaporator liquid level control effect is characterized by controlling the opening of the regulating valve between the effects, so that the industrial steam pressure Pₛₜₑₐₘ is maintained between 5-35 cm during the fluctuation process, and no empty tank and flooding phenomenon occurs.

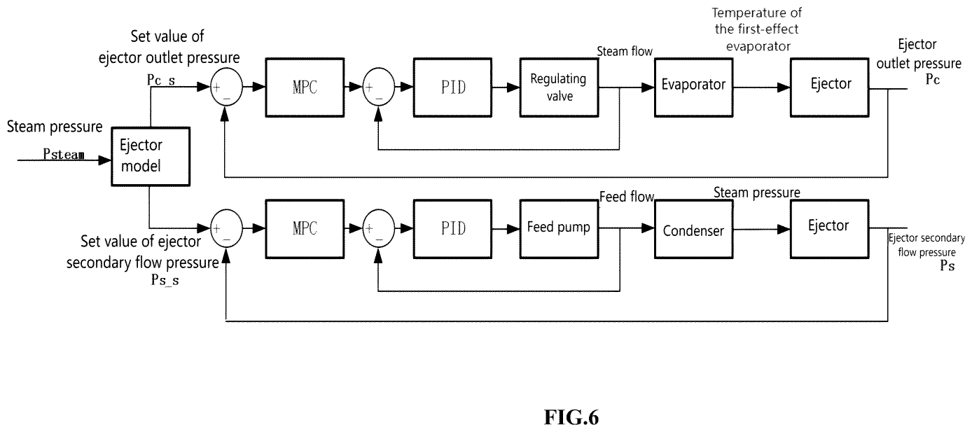

As shown in FIG. 6, is a diagram of a steam injector working condition control system. For the steam ejector working condition control, because the primary flow pressure Pₘ of the ejector is highly correlated with the industrial steam pressure Pₛₜₑₐₘ, which belongs to the external disturbance is not within the control range. Therefore, the characteristic of ejector condition control is that the pressure Pₘ of the primary inlet is not controlled, by modeling the steam ejector, an outlet pressure P_{c} and a secondary flow pressure Pₛ of the steam ejector that meets the ejection performance of the steam ejector under different primary inlet pressures Pₘ are obtained, by controlling the outlet pressure P_{c} and the secondary flow pressure Pₛ of the steam ejector, controlling the ejection performance of the steam ejector is realized, the purpose of the system's water production ratio not less than 8 is achieved.

For the steam ejector modeling method, because the ejector is a nonlinear link, its modeling feature is based on a data-driven modeling method, data of the fluctuation range of industrial steam pressure that satisfies the secondary flow pressure Pₛ and outlet pressure P_{c} of the ejection performance of the steam ejector is obtained through experiments, in the actual control, control targets of the secondary flow pressure Pₛ and the outlet pressure P_{c} of the steam ejector are obtained via the look-up table method, so as to achieve the purpose of linearizing the control object.

For the ejector outlet pressure P_{c} control, the control method is characterized by controlling the outlet steam flow of the ejector to further control the temperature of the first-effect evaporator, and finally achieve the purpose of controlling the outlet pressure P_{c} of the ejector. For the control of the outlet pressure P_{c} of the ejector, the control system is characterized by a cascade control system, the inner loop of the system controls the steam flow rate by PID controlling the regulating valve opening, and the outer loop controls the outlet pressure of the ejector by adjusting the set value of the steam flow rate via model predictive control, and the set value of an outlet pressure P_{c_s} of steam ejector is obtained via the look-up table method.

For the secondary flow pressure Pₛ control of the ejector, the control mode is characterized by controlling the feed rate of feedstock water, further controlling the steam pressure of the condenser, and further controlling the secondary flow pressure Pₛ of the ejector. For the secondary flow pressure Pₛ control of the ejector, the control system is characterized by a cascade control system, the inner loop of the system controls the inlet feedstock water flow by PID controlling the feed pump frequency, the outer loop controls the secondary flow pressure of the ejector by model predictive control controlling the set value of the inlet feedstock water flow, and the set value of a secondary flow pressure P_{s_s} of the ejector is obtained via looking up the table.

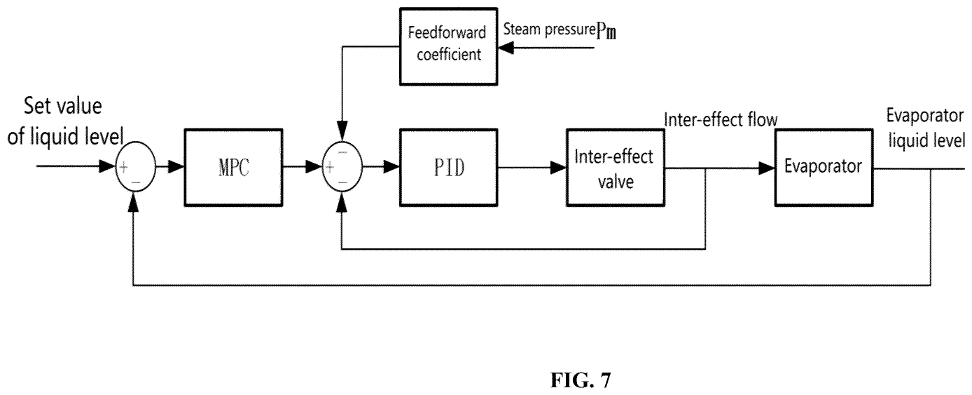

As shown in FIG. 7, is a diagram of a single-effect liquid level control system. For the evaporator liquid level control, due to the large degree of coupling between the liquid level control of each effect evaporator, and for each effect evaporator, there is an inter-effect valve that needs to be controlled for opening, which belongs to the multivariable coupling system. Therefore, the characteristics of the liquid level control method of the evaporator are based on the model predictive control method, and the liquid level control system of each effect is taken as a subsystem, after a main system is combined with the liquid level data of each effect, issues control requirements to each subsystem to realize a distributed model predictive control structure, the control requirements issued by the system are characterized by the Nash optimal solution obtained by Nash optimization to achieve the decoupling of the control system. The main system is the superior system that issues control commands to the subsystem, which is well known to the technicians in this art.

The control mode of the model predictive control subsystem is characterized by establishing the relationship equations of evaporator pressure, liquid level and inter-effect flow through mechanism modeling, so as to achieve the purpose of accurately controlling the liquid level by controlling the inter-effect flow.

Further, the model predictive control subsystem is characterized by the use of feedforward plus cascade model predictive control, the inner loop adopts PID control, the inter-effect flow is controlled by controlling the inter-effect valve opening, the outer loop adopts model predictive control to modify the PID set value of the inter-effect flow according to the evaporator liquid level, and the evaporator pressure further modifies the PID set value of the inter-effect flow through feedforward control.

Therefore, the present invention adopts the above-mentioned thermocompression multi-effect water distiller system and its control method, the heat exchange efficiency is greatly improved, and a new control system is proposed, which can realize the normal operation in the range of 40%-200% of the set working conditions, and ensure the stable and efficient operation of the equipment.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A thermocompression multi-effect water distiller system, comprising a distillation unit and a control unit;
the distillation unit comprises a multi-effect evaporator;
the multi-effect evaporator is a horizontal tube falling film evaporator and is arranged side by side, the shell side of the former-effect evaporator is connected with the tube side of the latter-effect evaporator;
the control unit controls the distillation unit during the working process, the control unit is a feedforward cascade fuzzy PID model predictive control system, which comprises an inner loop control system and an outer loop control system;
the inner loop control system is fuzzy PID control, for controlling the flow rate via the pump and controlling the steam pressure via a valve opening, according to a deviation and a deviation change rate of a current controlled quantity, a fuzzy control method is used to form a fuzzy control rule;
a control system for industrial steam pressure P_steam fluctuation is arranged on the inner loop control system;
the outer loop control system is model predictive control, and a system performance, a reference trajectory tracking performance and a change degree of the inner loop setting value are taken as an optimization objective, based on the inner loop setting value and the state constraint conditions of the thermocompression multi-effect water distiller system, a rolling optimization model is established:
$$min J ( k ) = {\sum }_{i = 1}^{P} {q}_{i} \cdot {[ w ( k + i ) - {y}_{p} ( k + i \vert k ) ]}^{2} + {\sum }_{j = 1}^{M} [ {p}_{i} \cdot Δ {r}_{sp}^{2} ( k + j - 1 ) + {λ}_{i} \cdot {EX}^{2} ( {r}_{s p} ( k + j ) ) ]$$
$$s . t . {x}_{min} \leq x ( k + i \vert k ) \leq {x}_{max} , i = 1 , 2 , … , P$$
$${r}_{sp , min} \leq {r}_{s p} ( k + j ) \leq {r}_{sp , max} , j = 1 , 2 , … , M$$
$$Δ {r}_{sp , min} \leq Δ {r}_{s p} ( k + j - 1 ) \leq Δ {r}_{sp , max} , j = 1 , 2 , … , M$$
where J(k) is a set optimization objective function; EX(rₛₚ) is a system performance evaluation function; w(k+i) and yₚ(k+i|k) are a reference trajectory for the moment of k+i moment and a predicted output for k+i moment at k moment, respectively; xₘᵢₙ and xₘₐₓ are minimum and maximum values of key state parameters of the system; x(k+i|k) is a predicted value of the system state parameters at k moment for k+i moment; r_{sp,min} and r_{sp,max} are minimum and maximum values of the output value of the model predictive controller to the inner loop controller; rₛₚ(k+j) is an output value of model predictive controller to the inner loop controller at k+j moment; Δr_{sp,min} and Δr_{sp,max} are minimum and maximum change rates of the output values of the model predictive controller to the inner loop controller; Δrₛₚ(k+j−1) is a change rate of the output value of the model predictive controller to the inner loop controller at k+j−1 moment; P is a prediction time domain; i is a i^{th} moment of the prediction time domain; M is a control time domain; j is a j^{th} moment of the control time domain; pᵢ, λᵢ and qᵢ are weight coefficients at the i^{th} moment.

2. The thermocompression multi-effect water distiller system according to claim 1, the distillation unit also comprises a pure steam generator, a steam ejector, a feedstock pure water buffer tank, a condensate water buffer tank and a waste heat recovery system;
the waste heat recovery system is used to preheat the feedstock pure water, and a feedstock pure water pump, a concentrated drainage preheater, an industrial condensate water secondary preheater, a condenser, a product water preheater and an industrial condensate water primary preheater are arranged successively from the feedstock pure water end;
a water inlet end of the pure steam generator tube side is connected with the feedstock pure water buffer tank via a steam generator pump, and a steam inlet end of shell side is connected with an industrial steam pipeline; an industrial condensate water discharge end is connected with the industrial condensate water primary preheater, and a concentrated drainage discharge end is connected with the concentrated drainage preheater.

3. The thermocompression multi-effect water distiller system according to claim 2, in the multi-effect evaporator, a steam inlet end of a first-effect evaporator is connected with an outlet end of the steam ejector, and a secondary inlet end of the steam ejector is connected with a steam outlet end of a last-effect evaporator;
the last-effect evaporator is also connected with the condenser, the feedstock pure water buffer tank and the condensate water buffer tank respectively, wherein, a steam outlet of a condensation side head of the last-effect evaporator is connected with an inlet of the shell side of the condenser, an evaporation residual water outlet of an intermediate cylinder of the last-effect evaporator is connected with the feedstock pure water buffer tank, and the condensate water outlet of the condensation side head of the last-effect evaporator is connected with the condensate water buffer tank;
the feedstock pure water buffer tank is connected with the industrial condensate water primary preheater via a circulating water pump, and the industrial condensate water primary preheater is connected with a spray liquid distribution system of the multi-effect evaporator;
a liquid distributor is arranged on the spray liquid distribution system;
the number of liquid distributors is the same as the number of effects of multi-effect evaporators, and each liquid distributor is located directly above each effect evaporator.

4. The thermocompression multi-effect water distiller system according to claim 3, a pure steam outlet end of the pure steam generator is connected to a primary inlet of the steam ejector.

5. The thermocompression multi-effect water distiller system according to claim 4, the last-effect evaporator is also connected with the condensate water buffer tank, the condensate water buffer tank outputs product water through a product water row pipe, the product water row pipe comprises a first-row pipe, an end of the first-row pipe is connected with a second-row pipe of qualified product water and a third-row pipe of unqualified product water respectively, the water quality is detected by an online conductivity detector, and then the switches of the second-row pipe valve and the third-row pipe valve are controlled;
a product water pump is arranged on the first-row pipe.

6. A control method for a thermocompression multi-effect water distiller system according to claim 1, the inner loop control system is a single-input and single-output control, for controlling the flow rate via the pump and controlling the steam pressure via the valve opening, according to the deviation and deviation change rate of the current controlled quantity, a fuzzy control method is used to form a fuzzy control rule;
the outer loop control system is model predictive control, and a system performance, a reference trajectory tracking performance and a change degree of the inner loop setting value are taken as an optimization objective, based on the inner loop setting value and the state constraint conditions of the thermocompression multi-effect water distiller system, a rolling optimization model is established:
$$min J ( k ) = {\sum }_{i = 1}^{P} {q}_{i} \cdot {[ w ( k + i ) - {y}_{p} ( k + i \vert k ) ]}^{2} + {\sum }_{j = 1}^{M} [ {p}_{i} \cdot Δ {r}_{sp}^{2} ( k + j - 1 ) + {λ}_{i} \cdot {EX}^{2} ( {r}_{s p} ( k + j ) ) ]$$
$$s . t . {x}_{min} \leq x ( k + i \vert k ) \leq {x}_{max} , i = 1 , 2 , … , P$$
$${r}_{sp , min} \leq {r}_{s p} ( k + j ) \leq {r}_{sp , max} , j = 1 , 2 , … , M$$
$$Δ {r}_{sp , min} \leq Δ {r}_{s p} ( k + j - 1 ) \leq Δ {r}_{sp , max} , j = 1 , 2 , … , M$$
where J(k) is a set optimization objective function; EX(rₛₚ) is a system performance evaluation function; w(k+i) and yₚ(k+i|k) are a reference trajectory for the moment of k+i moment and a predicted output for k+i moment at k moment, respectively; xₘᵢₙ and xₘₐₓ are minimum and maximum values of key state parameters of the system; x(k+i|k) is a predicted value of the system state parameters at k moment for k+i moment; r_{sp,min} and r_{sp,max} are minimum and maximum values of the output value of the model predictive controller to the inner loop controller; rₛₚ(k+j) is an output value of model predictive controller to the inner loop controller at k+j moment; Δr_{sp,min} and Δr_{sp,max} are minimum and maximum change rates of the output values of the model predictive controller to the inner loop controller; Δrₛₚ(k+j−1) is a change rate of the output value of the model predictive controller to the inner loop controller at k+j−1 moment; P is a prediction time domain; i is a i^{th} moment of the prediction time domain; M is a control time domain; j is a j^{th} moment of the control time domain; pᵢ, λᵢ and qᵢ are weight coefficients at the i^{th} moment; according to a process flow of the equipment, the intermediate controlled variables of the control system are mainly a circulating water flow F_{cir}, a feedstock water flow F_{feed}, an inlet feedstock water flow Fᵢₙ, a product water flow Fa, a preheating steam pressure Pₚᵣₑ and a heating steam pressure Pₕ; since the flow control is realized by the water pump, and the pressure control is realized by a steam pressure regulating valve, a control amount u is the frequency of each pump and the opening of the pressure regulating valve:
$$u = {[ {f}_{pump , cir} , {f}_{pump , feed} , {f}_{pump , in} , {f}_{pump , d} , {V}_{pre} , {V}_{h} ]}^{T}$$
where f_{pump,cir} is a frequency of the circulating pump; f_{pump,feed} is a feed pump frequency; f_{pump,in} is a feed pump frequency of the steam generator; f_{pump,d} is a product water pump frequency; Vₚᵣₑ is a valve opening of the steam preheating pipeline; Vₕ is an opening of the industrial steam valve;
for this equipment, the control system needs to regulate and control a three-port pressure to ensure that the steam ejector operates in an optimal state, and then a final output y of the system is a primary flow pressure Pₘ, a secondary flow pressure Pₛ and an outlet pressure P_{c} of the steam ejector:
$$y = {[ {P}_{m} , {P}_{s} , {P}_{c} ]}^{T}$$
in industrial applications, disturbance variables d of the system are an industrial steam pressure Pₛₜₑₐₘ and an inlet feedstock water temperature T_{feed}:
$$d = {[ {P}_{s t eam} , {T}_{f e e d} ]}^{T} .$$

7. The control method for a thermocompression multi-effect water distiller system according to claim 6, the control system for industrial steam pressure Pₛₜₑₐₘ fluctuation comprises an ejector working condition control system and an evaporator liquid level control system;
the ejector working condition control system ensures that a water production ratio of the system is not less than 8;
the evaporator liquid level control system controls the opening of the inter-effect control valve to keep the liquid level of the inter-effect between 5-35 cm during the industrial steam pressure Pₛₜₑₐₘ fluctuation.

8. The control method for a thermocompression multi-effect water distiller system according to claim 7, for the steam ejector working condition control, by modeling the steam ejector, an outlet pressure P_{c} and a secondary flow pressure Pₛ of the steam ejector that meets the ejection performance of the steam ejector under different primary inlet pressures Pₘ are obtained, by controlling the outlet pressure P_{c} and the secondary flow pressure Pₛ of the steam ejector, controlling the ejection performance of the steam ejector is realized, the purpose of the system's water production ratio not less than 8 is achieved;
for the steam ejector modeling method, because the ejector is a nonlinear link, the modeling method is based on a data-driven modeling method; data of the fluctuation range of industrial steam pressure that satisfies the secondary flow pressure Pₛ and outlet pressure P_{c} of the ejection performance of the steam ejector is obtained, in the actual control, control targets of the secondary flow pressure Pₛ and the outlet pressure P_{c} of the steam ejector are obtained via the look-up table method, so as to achieve the purpose of linearizing the steam ejector;
the outlet pressure P_{c} control mode of the steam ejector is to control the outlet pressure P_{c} of the steam ejector via controlling the outlet steam flow of the steam ejector and controlling the temperature of the first-effect evaporator;
the outlet pressure P_{c} control mode of the steam ejector adopts a cascade control system, the inner loop of the system controls the steam flow by PID controlling the regulating valve opening, and the outer loop controls the outlet pressure of the steam ejector by adjusting the set value of steam flow via model predictive control, and a set value of an outlet pressure P_{c_s} of steam ejector is obtained via looking up the table;
the secondary flow pressure Pₛ control method of steam ejector controls the steam pressure of the condenser by controlling the feed rate of feedstock water, and further controls the secondary flow pressure Pₛ of the steam ejector;
the secondary flow pressure Pₛ control method of steam ejector adopts a cascade control system, the inner loop of the system controls the inlet feedstock water flow by PID controlling the feed pump frequency, the outer loop controls the secondary flow pressure of the steam ejector by model predictive control controlling the set value of the inlet feedstock water flow, and the set value of a secondary flow pressure P_{s_s} of the steam ejector is obtained via looking up the table.

9. The control method for a thermocompression multi-effect water distiller system according to claim 8, a liquid level control method of the evaporator is based on the model predictive control method, wherein the liquid level control system of each effect is taken as a subsystem, and a main system is a combination with the liquid level data of each effect, issues control requirements to each subsystem to realize a distributed model predictive control structure; the control requirement issued by the main system is the Nash optimal solution obtained according to the Nash optimization;
the subsystem control method establishes the relationship equation of evaporator pressure, liquid level and inter-effect flow by means of mechanism modeling, so as to achieve the purpose of accurately controlling the liquid level by controlling the inter-effect flow;
the subsystem control method adopts feedforward plus cascade model predictive control, the inner loop adopts PID control, the inter-effect flow is controlled by controlling the inter-effect valve opening, and the outer loop adopts model predictive control to modify the PID set value of the inter-effect flow according to the evaporator liquid level, and the evaporator pressure further modifies the PID set value of the inter-effect flow through feedforward control.
